(19) United States
(12) Patent Application Publication
(10) Pub. No.: US 2013/0262340 A1
(43) Pub. Date: Oct. 3, 2013

(54) EQUIPMENT FOR DATA PROCESSING AND A METHOD FOR DETERMINING THE WEIGHTINGS OF CONSTITUENTS OF A TARGET PORTFOLIO

(71) Applicant: Ralf Seiz, Rapperswil (CH)

(72) Inventor: Ralf Seiz, Rapperswil (CH)

(73) Assignee: FINREON AG, St. Gallen (CH)

(21) Appl. No.: 13/852,098

(22) Filed: Mar. 28, 2013

(30) Foreign Application Priority Data
Apr. 2, 2012 (CH) CH457/12

(51) Int. Cl. G06Q 40/06

(52) U.S. Cl. CPC G06Q 40/06
USPC 705/36 R

(57) ABSTRACT

Equipment for data processing comprises a first input device for acquiring historical data of constituents of a defined investment universe, a storage for placing the acquired historical data in a first data structure, a first processor for generating a second data structure which corresponds to a subset of the first data structure selected according to specifiable criteria, wherein the second data structure is placed in the storage. The equipment further comprises a predictor for estimating a future volatility of the constituents of the second data structure, a second processor for generating a third data structure that is determined from the estimated future volatility. A third processor generates a fourth data structure that corresponds to an interpolation between the second data structure and the third data structure. Information based on the fourth data structure comprises weightings of constituents of a target portfolio.

### CROSS-REFERENCE TO RELATED APPLICATIONS

This application claims priority to Swiss Patent Application No. CH457/12 filed Apr. 2, 2012, which is incorporated herein by reference and made a part hereof.

### BACKGROUND OF THE INVENTION

1. Field of the Invention

The invention relates to equipment for data processing and a method for determining the weightings of constituents of a target portfolio.

2. Description of the Related Art

Electronic data processing, and the associated possibilities for processing extensive quantities of data, for carrying out elaborate calculations, and for solving multi-dimensional, non-linear optimization problems have permitted the improvement and optimization of known designs in many fields, such as in engineering or in the modelling of complex systems. The present invention relates to the application of data processing to the determination of a target portfolio of investment values which, with regard to important properties, to risk in particular, is advantageous in comparison with portfolios that are assembled with known means, and which, when necessary, can easily be adapted to the needs of the investor.

It has long been known that purely passive investments weighted according to market capitalization are inefficient, and bring significant problems with them (J. Treynor: “Why Market-Valuation-Indifferent Indexing Works”, Financial Analysts Journal, September/October 2005; 61, 5; V. DeMiguel et al.: “Optimal Versus Naive Diversification: How Inefficient is the 1/N Portfolio Strategy?”, Rev. Financ. Stud. (2009) 22 (5): 1915). On the one hand, investments in market-weighted share indexes frequently lead to cluster risks, that is unsystematic risks that are not compensated by the capital market. On the other hand, such investments entail what is known as the passive noise effect, i.e. undervalued securities are under-weighted, while overvalued securities are over-weighted. One option for solving both problems is equal weighting, which, by definition, avoids cluster risks, and which, moreover, breaks the rigid relationship between price and weight. Equal weighting is, however, itself inefficient, since the relationships between the price trends of different securities are not taken into account. Under some circumstances, equal weighting can also lead to liquidity problems, since as much investment is put into small-cap stocks as into blue chips.

### SUMMARY OF THE INVENTION

The task of the invention is therefore to provide equipment for data processing belonging to the technical field mentioned at the beginning and a method for determining the weightings of constituents of a target portfolio, by means of which a target portfolio that is improved, in particular from the point of view of risk, can be determined.

The solution to the task is defined by the characteristics of claims 1 and 9. According to one embodiment of the invention, equipment for data processing comprises the following:

a) a first input device for acquiring historical data of constituents of a defined investment universe;

b) a storage for placing the acquired historical data in a first data structure;

c) a first processor for generating a second data structure which corresponds to a subset of the first data structure, selected according to specifiable criteria, wherein the second data structure is placed in the means of storage;

d) a predictor for estimating a future volatility of the constituents of the second data structure;

e) a second processor for generating a third data structure that corresponds to a minimum-variance portfolio of the constituents of the second data structure, wherein elements of the third data structure are determined from the estimated future volatility;

f) a third processor for generating a fourth data structure that corresponds to an interpolation between the second data structure and the third data structure;

g) an output device for outputting information based on the fourth data structure, wherein the information comprises weightings of constituents of a target portfolio.

Correspondingly, the following steps are carried out in a method for determining the weightings of constituents of a target portfolio in equipment for data processing:

a) reading historical data of constituents of a defined investment universe into the equipment for data processing;

b) placing the acquired historical data in a first data structure in a storage of the equipment for data processing;

c) generating a second data structure which corresponds to a subset of the first data structure selected according to specifiable criteria, wherein the second data structure is placed in the storage;

d) estimating the future volatility of the constituents of the second data structure;

e) generating a third data structure that corresponds to a minimum-variance portfolio of the constituents of the second data structure, wherein elements of the third data structure are determined from the estimated volatility;

f) generating a fourth data structure that corresponds to an interpolation between the second data structure and the third data structure;

g) outputting information, based on the fourth data structure, comprising weightings of constituents of a target portfolio.

The input device can be a connection to an external database, either via a direct connection or over a network (LAN, WAN, Internet etc.). Alternatively, the data can be read from a data medium. The processors and the predictor can be formed of software and/or hardware modules, and can be implemented on the same computer or on different computers.

The second data structure does not have to be a true subset of the first data structure. Depending on the specifiable criteria, a selection can result for the second data structure that comprises all the elements of the first data structure.

The specifiable investment universe can, for instance, be a list of investment securities (or a part of the investment securities) of a country or region, a particular selection of the globally available securities, or else a list of securities that satisfy particular non-geographical criteria. The securities can include shares, bonds and/or raw materials.

The weightings determined with the equipment according to the invention or with the method according to one embodiment of the invention make it possible immediately to assemble the target portfolio, in that the number of individual securities is specified according to the weightings depending on the investment capital. It has been found that with the aid of the equipment for data processing according to one embodiment of the invention or with the method according to one embodiment of the invention, a target portfolio that possesses advantageous properties, in particular from the point of view of risk, can be determined from a defined investment universe. In addition to the associated gain in efficiency, the above-mentioned disadvantages of the equally weighted portfolio are overcome or are at least sharply minimized, without having to accept the disadvantages of market capital weighted investments.

The scope of the second data structure can advantageously be specified. This scope simultaneously determines the maximum number of securities in the target portfolio. In this way its width can be predetermined in accordance with the needs of the investor.

Alternatively, only the above-mentioned criteria can be specified, and all securities that satisfy these criteria (e.g. market capitalization) become part of the second data structure. The securities are thus not necessarily also part of the target portfolio, since the further calculations may show that certain securities should not be represented in the target portfolio.

The first input device is advantageously connected to a database that comprises time series of market values of the constituents of the defined investment universe as historical data. The database can be a part of the equipment for data processing, but may also be made available externally, e.g. by an appropriate service provider. The database is advantageously updated regularly (e.g. daily, weekly or monthly, appropriately for the investment horizon). Access is effectuated, for example, over a network (LAN, WAN or the Internet), and a web service can also be employed.

The predictor advantageously estimates the future volatility in a manner that is, in itself, known, by means of a GARCH model (T. Bollerslev: Generalized Autoregressive Conditional Heteroskedasticity. In: Journal of Econometrics, Vol.: 31 No.: 3, pp. 307-327, 1986). Other modelling is possible, such as through stochastic volatility (SV) models (see, e.g., S. L. Heston: “A Closed-Form Solution for Options with Stochastic Volatility with Applications to Bond and Currency Options”, Rev. Financ. Stud. (1993) 6 (2): 327).

The second processor preferably determines a covariance matrix based on the estimated future volatility of the constituents of the second data structure. In a further step, the third data structure is obtained from this covariance matrix. This allows the relationships between the price trends of various securities to be taken into account, and finally also the determination of the minimum-variance portfolio.

When interpolating between the second data structure and the third data structure, the second data structure can be treated as an equally weighted portfolio. This means that when the number of securities in the second data structure is n, each security is given the weighting of 1/n. The equally weighted portfolio can be obtained without further calculations from the subset of the first data structure that has once been determined. It has, moreover, been found that an interpolation between the equally weighted portfolio and the minimum-variance portfolio is advantageous in terms of the desired properties of the target portfolio.

Alternatively, the weighting of the second data structure is modified for the interpolation, e.g. according to individual cases, or on the basis of specified criteria (such as the market capitalization).

Favorably the equipment comprises a second input device for acquiring a specifiable parameter, wherein the third processor takes the acquired parameter into account as a weighting of the third data structure in relationship to the second data structure when interpolating. (It goes without saying that this specifiable parameter may alternatively for instance be the weighting for elements of the third data structure, the ratio of this weighting to the weighting for elements of the second data structure, or may be the weighting for elements of the second data structure.)

With the aid of this parameter it is easily possible to meet investor-specific needs, e.g. from the point of view of the risk to be taken. If the second data structure is dominant in the target portfolio, the properties of the target portfolio approach those of the portfolio according to the second data structure (that is, for instance, of the equally weighted portfolio) (relatively high risk, relatively high potential returns); conversely, if the first data structure is dominant, the properties approach those of the minimum-variance portfolio (relatively low risk, moderate returns).

It is possible with the aid of the parameter, in the simplest case, to generate a linear scaling of the weightings of the securities according to the two data structures. If the two portfolios between which the interpolation is to take place are the equally weighted portfolio (corresponding to the second data structure) and the minimum-variance portfolio (corresponding to the third data structure) and if it is possible to specify a parameter 0<α<1, the following weighting of security i results in the target portfolio:

$${w}_{i}^{TP} = α {w}_{i}^{MV} + ( 1 - α ) {w}_{i}^{EW} = α {w}_{i}^{MV} + ( 1 - α ) \frac{1}{n} ,$$

where wᵢ^{TP}, wᵢ^{MV} and wᵢ^{EW} represent the respective weightings of the security i in the target portfolio, in the minimum-variance portfolio and in the equally weighted portfolio.

The parameter can also affect the interpolation in other ways (including non-linear ways), while multiple specifiable parameters that affect the interpolation are, moreover, possible.

The equipment for data processing advantageously comprises an interface through which information based on the fourth data structure can be conveyed to a data-processing installation of a user and/or service provider. The information can then be directly further processed there. It is conceivable that, for instance, purchases or sales of securities according to the target portfolio, or according to a difference between the target portfolio and an existing portfolio, are automatically triggered. The information is conveyed, for example, over a web service.

Further advantageous embodiments and combinations of features of the invention emerge from the following detailed description and from the totality of the patent claims.

### BRIEF DESCRIPTION OF THE ACCOMPANYING DRAWINGS

The drawings used to explain the exemplary embodiment show:

FIG. 1 is a schematic illustration of equipment according to the invention for data processing;

FIG. 2 is a schematic illustration of the important properties of an equally weighted portfolio, a minimum-variance portfolio, and a target portfolio according to the invention, compared with a benchmark portfolio; and

FIG. 3 is a schematic illustration of the data structures according to the invention.

Identical parts in the figures are all given the same reference numbers.

### DETAILED DESCRIPTION OF THE PREFERRED EMBODIMENTS

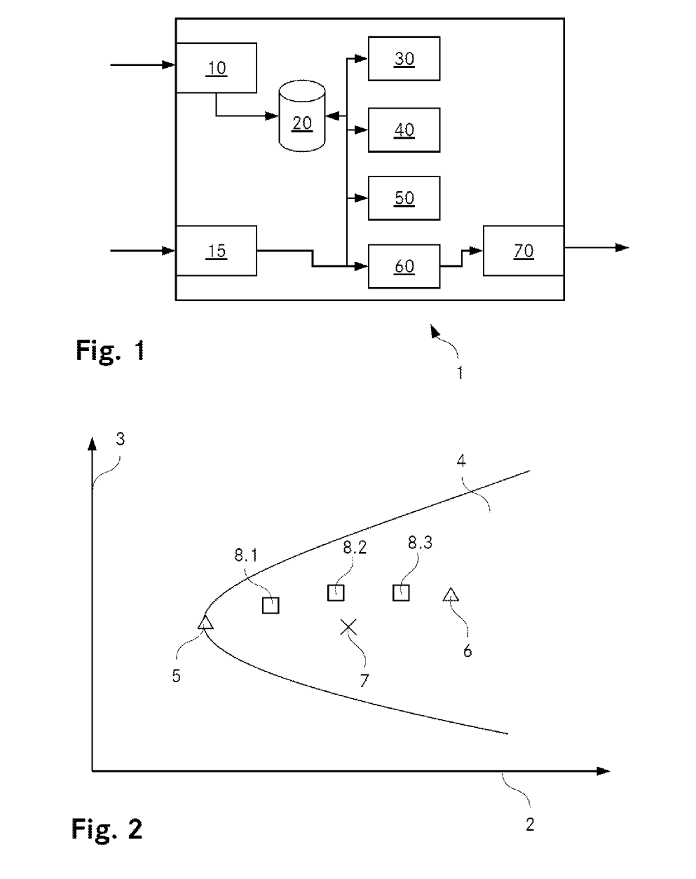

FIG. 1 shows a schematic illustration of equipment according to the invention for data processing. The equipment 1 comprises a first input module 10 through which data relating to investment securities, in particular indications of the securities and a price performance over an earlier period of time, can be read. The input module comprises, for example, at least one network card and software, wherein the latter controls the exchange of data with the external source (query, receipt of the data, storage). The data received is stored in a memory 20 in the form of a suitable data structure.

The data concerns investment securities of what is known as an investment universe. This can, for instance, involve a universe such as “Swiss shares” or “USA shares”. A combination of multiple regions such as, for example, “German and Swiss shares” is also possible. An investment universe that does not correspond to any known index is also conceivable. The investment universe, moreover, is not just restricted to shares, but can comprise securities of any kind (e.g. bonds, raw materials etc.).

In a first processing module 30 a selection is made from the securities that are the basis for the received data. This selection can, for example, be made on the basis of a selection criterion: if this is satisfied, the security is selected, but if it is not satisfied, it is not selected. One possible criterion is the market capitalization. A selection of this type will not always generally result in the same number of securities, but this number will depend on the number of securities in the received data, on the content of the data, which has an effect on fulfilment of the criterion, and on the criterion itself. If a selection having a specific number n of securities is wanted, this specific number can be specified; the securities in the received data are then sorted according to a sorting criterion (where the sorting criterion may or may not be identical with a possible selection criterion). The first n securities of this sorted list of securities are then considered. The number n can have a fixed specification in the system, can be read in with the input data, can be determined on the basis of the number of securities in the investment universe, or may be specially defined by the user (e.g. in the context of a user dialog). The selected securities and the relevant associated data (in particular the time series) from the data structure mentioned above are then stored as a further data structure in the memory 20.

In terms of the exemplary embodiment, the data that is read in comprises an unambiguous identification of the security together with the market values over the previous 36 months (one value per month in each case). On the basis of these historical value series for each of the n securities in the selection in the second data structure, the future volatilities of the securities can now be determined in a modelling module 40.

For this purpose, the historical returns are first calculated as a simple percentage deviation from one price to the next. On the basis of the series of returns calculated in this way, the historical volatilities are then calculated as annualized standard deviations (with a sliding value range). These historical volatilities finally serve as the basis for estimating the future volatilities.

This estimation is carried out, in terms of the exemplary embodiment, using what is known as the GARCH model (generalized autoregressive conditional heteroscedasticity), which in itself is known. More precise information is to be found in T. Bollerslev: Generalized Autoregressive Conditional Heteroskedasticity. In: Journal of Econometrics, Vol.: 31 No.: 3, pp. 307-327, 1986). Other modelling is possible, such as through stochastic volatility (SV) models (Taylor, S. J. (1982). Financial returns modelled by the product of two stochastic processes—a study of daily sugar prices 1961-79. In O. D. Anderson (Ed.), Time Series Analysis: Theory and Practice, 1, pp. 203{226. Amsterdam: North Holland.

In a further processing module 50 these future volatilities can be used to determine what is known as the minimum-variance portfolio (with reference to the n selected securities). For this purpose, the covariance matrix E is prepared from the estimated future volatilities. A weighting wᵢ is then assigned to each security. By minimizing the portfolio variance, with the supplementary condition that the weightings wᵢ together add up to 1, the weightings wᵢ^{MV} of the minimum-variance portfolio are then calculated (cf. e.g. Elton, Gruber, Brown & Goetzmann, Modern Portfolio Theory and Investment Analysis, 7th edition, 2007, pp. 56-58, 75-76). The minimization can, for instance, be carried out with the aid of a Hesse matrix, which in itself is known. The minimum-variance portfolio (or, more precisely, at least the weightings of the individual securities which correspond to the minimum-variance portfolio) is placed as a further data structure in the memory 20.

A parameter α is read in through a second input module 15, and supplied to a further processing module 60. An equally weighted portfolio, which results from the data structure placed by the first processing module 30 in the memory 20 if each security is assigned a weighting of 1/n, and the minimum-variance portfolio are then combined as follows:

$${w}_{i}^{TP} = α {w}_{i}^{MV} + ( 1 - α ) {w}_{i}^{EW} = α {w}_{i}^{MV} + ( 1 - α ) \frac{1}{n} .$$

In the special case of α=0 the equally weighted portfolio again results, while in the other special case of α=1 the minimum-variance portfolio is obtained. If the parameter α is in between, then a genuine interpolation is carried out according to the invention, defining a new portfolio, the target portfolio.

The target portfolio, i.e. the weightings that have been determined, can ultimately be output through an output module 70, such as onto a screen or directly over a network to a customer or to a service provider who makes purchases and/or sales according to the portfolio and, if relevant, existing values in a current portfolio of a customer.

FIG. 2 shows a schematic illustration of the important properties of an equally weighted portfolio, a minimum-variance portfolio, and various target portfolios according to the invention, compared with a benchmark portfolio. The portfolios are positioned in a coordinate system whose horizontal axis 2 represents the investment risk (standard deviation) of the portfolio concerned, whereas the vertical axis 3 illustrates the expected returns on the portfolio concerned. Since this is a qualitative overview, the axes are without scales.

It is known that real investment portfolios are to be found in a region 4 of the diagram that is limited in such a way that each portfolio implies a certain minimum investment risk, whereas the bandwidth of the possible returns rises as the risk increases. The minimum-variance portfolio corresponds to a portfolio with the minimum risk. The minimum-variance portfolio, which is determined in the context of the invention on the basis of the estimated future volatilities, represents an approach to the “true” minimum-variance portfolio (which can only be determined retrospectively), and is thus located approximately at the boundary of the region 4 in the region of lowest risk (data point 5). The equally weighted portfolio is represented on the diagram by data point 6. The risk, and thereby the bandwidth of the possible returns, is as a rule higher. The diagram also shows (at data point 7) a market-weighted benchmark portfolio (based, for example, on a shares index).

Studies have now shown that the target portfolios that can be found through application of the invention, and which are illustrated on the diagram as data points 8.1, 8.2, 8.3 (depending on the parameter α), tend to exhibit a better yield/risk ratio than the equal weight portfolio, the minimum-variance portfolio and the market-weighted benchmark. As a result of the problems mentioned above associated with the pure equal weight portfolio and the pure minimum-variance portfolio, target portfolios that exhibit a substantive effect from both these portfolios are of particular interest; thus in the exemplary embodiment primary parameter values of 0.2<α<0.8 may be considered. If the investor is prepared to accept a higher risk he will tend to select a smaller value of α than when the need for security is high.

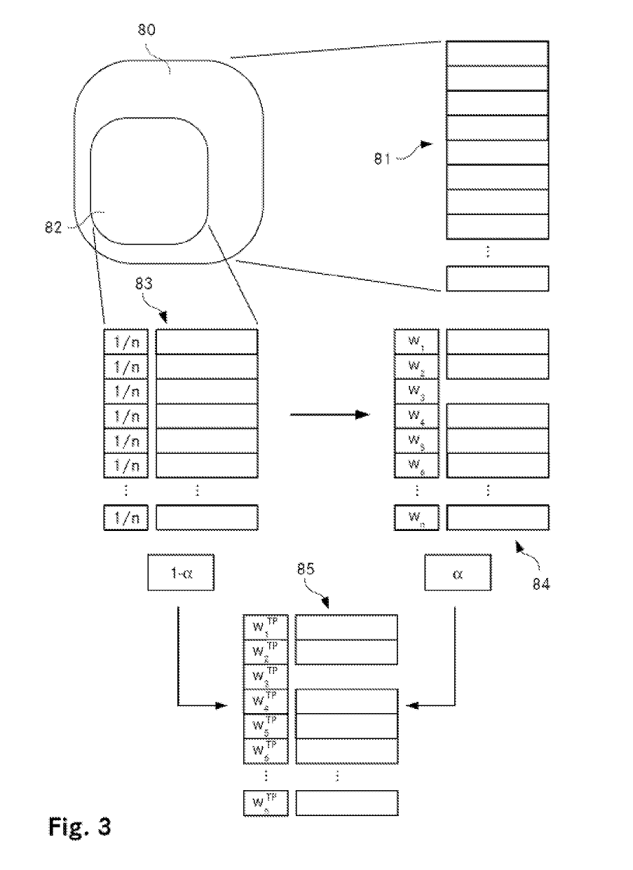

FIG. 3 shows a schematic illustration of the data structures according to the invention. The original investment universe 80 is represented by historical data (value series) for a number N of securities (data structure 81). This involves a specific number of market values being assigned to each (unambiguous) identification of a security, e.g. 36 values over the last 36 months.

With reference to a criterion, a number n≦N of securities is now selected from this investment universe (subset 82). A weighting of 1/n is assigned to each of these securities, so that all securities are equally weighted in the resultant portfolio. The portfolio is represented by a further data structure 83.

As described above, an estimate for a minimum-variance portfolio can ultimately be determined from the historical data. This is characterized by weightings w₁ . . . wₙ for each security, where the weightings are normalized and can adopt the value 0 for certain securities. The minimum-variance portfolio forms a data structure 84.

The target portfolio (data structure 85) is now obtained, in that the weightings of the data structures 83, 84 are multiplied by the coefficient 1-α or α, as a result of which new weightings wᵢ^{TP} are obtained, representing the proportions of the individual securities in the target portfolio.

The invention is not restricted to the exemplary embodiment that has been presented. The calculations can, in particular, also be carried out in other ways. The combination of the equally weighted portfolio and the minimum-variance portfolio can be characterized by more than one parameter, and is not restricted to a linear combination of the weighting vectors.

To summarize it can be said that the invention provides equipment for data processing and a method for determining the weightings of constituents of a target portfolio, by means of which a target portfolio that is improved, in particular from the point of view of risk, can be determined.

It has been found that the resulting target portfolio possesses advantageous properties, in particular with respect to risk. In addition to the associated gain in efficiency, the above-mentioned disadvantages of the equally weighted portfolio are overcome or are at least sharply minimized, without having to accept the disadvantages of market capital weighted investments.

While the system, apparatus, process and method herein described constitute preferred embodiments of this invention, it is to be understood that the invention is not limited to this precise system, apparatus, process and method, and that changes may be made therein without departing from the scope of the invention which is defined in the appended claims.

What is claimed is:

1. Equipment for data processing, comprising the following:
a) a first means of input for acquiring historical data of constituents of a defined investment universe;
b) a means of storage for placing the acquired historical data in a first data structure;
c) a first means of processing for generating a second data structure which corresponds to a subset of the first data structure, selected according to specifiable criteria, wherein the second data structure is placed in the means of storage;
d) a means of modelling for estimating a future volatility of the constituents of the second data structure;
e) a second means of processing for generating a third data structure that corresponds to a minimum-variance portfolio of the constituents of the second data structure, wherein elements of the third data structure are determined from the estimated future volatility;
f) a third means of processing for generating a fourth data structure that corresponds to an interpolation between the second data structure and the third data structure; and
g) a means of output for outputting information based on the fourth data structure, wherein the information comprises weightings of constituents of a target portfolio.

2. The equipment according to claim 1, wherein a scope of the second data structure can be specified.

3. The equipment according to claim 1, wherein the first means of input is connected to a database that comprises time series of market values of the constituents of the defined investment universe as historical data.

4. The equipment according to claim 1, wherein the means of modelling estimates the future volatility by means of a GARCH model.

5. The equipment according to claim 1, wherein the second means of processing determines a covariance matrix based on the estimated future volatility of the constituents of the second data structure.

6. The equipment according to claim 1, wherein the second data structure is included in the interpolation in the form of an equally weighted portfolio.

7. The equipment according to claim 1, wherein a second means of input for acquiring a specifiable parameter, wherein the third means of processing takes the acquired parameter into account as a weighting of the third data structure in relationship to the second data structure when interpolating.

8. The equipment according to claim 1, wherein an interface through which information based on the fourth data structure can be conveyed to a data-processing installation of a user and/or service provider.

9. A method for determining the weightings of constituents of a target portfolio, comprising the following steps:
a) reading historical data of constituents of a defined investment universe into equipment for data processing;
b) placing the acquired historical data in a first data structure in a storage of the equipment for data processing;
c) generating a second data structure which corresponds to a subset of the first data structure selected according to specifiable criteria, wherein the second data structure is placed in the storage;
d) estimating the future volatility of the constituents of the second data structure;
e) generating a third data structure that corresponds to a minimum-variance portfolio of the constituents of the second data structure, wherein elements of the third data structure are determined from the estimated volatility;
f) generating a fourth data structure that corresponds to an interpolation between the second data structure and the third data structure; and
g ) outputting information, based on the fourth data structure, comprising weightings of constituents of a target portfolio.

10. The method according to claim 9, wherein the future volatility is estimated by means of a GARCH model.

11. The method according to claim 8, wherein a covariance matrix based on the estimated future volatility of the constituents of the second data structure is determined.

12. The method according to claim 9, wherein the second data structure is included in the interpolation in the form of an equally weighted portfolio.

13. The method according to claim 9, wherein a specifiable parameter is read in, after which the parameter that has been read is taken into account as a weighting of the third data structure in relationship to the second data structure when interpolating.

14. Equipment for data processing, comprising the following:
h) a first input device for acquiring historical data of constituents of a defined investment universe;
i) a storage for placing the acquired historical data in a first data structure;
j) a first processor for generating a second data structure which corresponds to a subset of the first data structure, selected according to specifiable criteria, wherein the second data structure is placed in the storage;
k) a predictor for estimating a future volatility of the constituents of the second data structure;
l) a second processor for generating a third data structure that corresponds to a minimum-variance portfolio of the constituents of the second data structure, wherein elements of the third data structure are determined from the estimated future volatility;
m) a third processor for generating a fourth data structure that corresponds to an interpolation between the second data structure and the third data structure; and
n) an output device for outputting information based on the fourth data structure, wherein the information comprises weightings of constituents of a target portfolio.

15. The equipment according to claim 14, wherein a scope of the second data structure can be specified.

16. The equipment according to claim 14, wherein the first input device is connected to a database that comprises time series of market values of the constituents of the defined investment universe as historical data.

17. The equipment according to claim 14, wherein the predictor estimates the future volatility by means of a GARCH model.

18. The equipment according to claim 14, wherein the second processor determines a covariance matrix based on the estimated future volatility of the constituents of the second data structure.

19. The equipment according to claim 14, wherein the second data structure is included in the interpolation in the form of an equally weighted portfolio.

20. The equipment according to claim 14, wherein a second input device for acquiring a specifiable parameter, wherein the third processor takes the acquired parameter into account as a weighting of the third data structure in relationship to the second data structure when interpolating.

21. The equipment according to claim 14, wherein an interface through which information based on the fourth data structure can be conveyed to a data-processing installation of a user and/or service provider.
